(19) United States
(12) Patent Application Publication
(10) Pub. No.: US 2002/0117913 A1
(43) Pub. Date: Aug. 29, 2002

(54) Damping of resonant peaks in an electric motor, which is operated using a converter with a voltage intermediate circuit, by increasing the losses produced in the region of critical natural frequencies

(76) Inventors: Sebastian Raith, Erlangen (DE); Bernd Segger, Erlangen (DE)

Correspondence Address: BAKER & BOTTS, 30 ROCKEFELLER PLAZA, NEW YORK, NY, 10112

(21) Appl. No.: 09/918,654

(22) Filed: Jul. 31, 2001

(30) Foreign Application Priority Data
Dec. 22, 2000 (DE) 100 648 17.7

(51) Int. Cl. H02K 11/00

(52) U.S. Cl. 310/68 R

(57) ABSTRACT

In a converter system having a voltage intermediate circuit which operates with a mains system input inductor in the step-up controller mode or has other input-side inductances, there is a risk of natural system oscillations being formed via discharge capacitances in conjunction with motors. If the motor now has an amplitude/frequency response with a pronounced resonant frequency in the region of such natural system oscillations, then there is a risk of higher voltages occurring at the motor star point (S) than on the motor phases (U, V, W). This is prevented by the invention in that materials, particularly capacitive elements such as lossy dielectrics or inductive elements which produce eddy current losses are used for the stator in the motor, such that these materials result in increased losses being produced in the region of system oscillations (f_{sys}), which are stimulated asymmetrically with respect to ground potential, in the converter system (Lₖ, UR, L, M).

### FIELD OF THE INVENTION

The invention relates to a method for damping resonant peaks at a motor star point in the case of an electric motor which can be operated using a voltage intermediate-circuit converter having an input-side inductance, in particular a mains system input inductor, and which, on the basis of the characteristics of its winding sections, has a frequency response with at least one resonant frequency with respect to ground potential, and to a corresponding electric motor in which resonant peaks are damped in such a way.

In present-day converter systems with a voltage intermediate circuit, in particular in multi-shaft converter systems of such a type, system oscillations can be formed which are virtually undamped. This relates essentially to converters having a voltage intermediate circuit and having a regulated feeder in the form of a regulated mains-system-side converter, also referred to as an input converter.

Converters are in principle used for operating electric machines at a variable supply frequency. Such an intermediate circuit frequency converter allows an electric motor, for example a three-phase machine such as a synchronous machine, no longer to be operated directly from the mains system and hence at a fixed rotation speed, since the fixed mains system can be replaced by an electronically produced, variable-frequency and variable-amplitude mains system for supplying the electrical machine.

The two mains systems, firstly the supply mains system whose amplitude and frequency are fixed, and secondly the mains system supplying the electrical machine, whose amplitude and frequency are variable, are decoupled via a DC voltage store or a direct current store in the form of what is termed an intermediate circuit. Such intermediate circuit converters in this case essentially have three central assemblies:

a mains-system-side input converter, which can be designed to be uncontrolled (for example diode bridges) or controlled, in which case energy can be fed back into the mains system only when using a controlled input converter;

an energy store in the intermediate circuit in the form of a capacitor in a voltage intermediate circuit and an inductor in a current intermediate circuit;

an output-side machine converter or inverter for supplying the machine, which generally uses a three-phase bridge circuit having six active current devices which can be turned off, for example IGBT transistors, to convert the DC voltage in a voltage intermediate circuit into a three-phase voltage system.

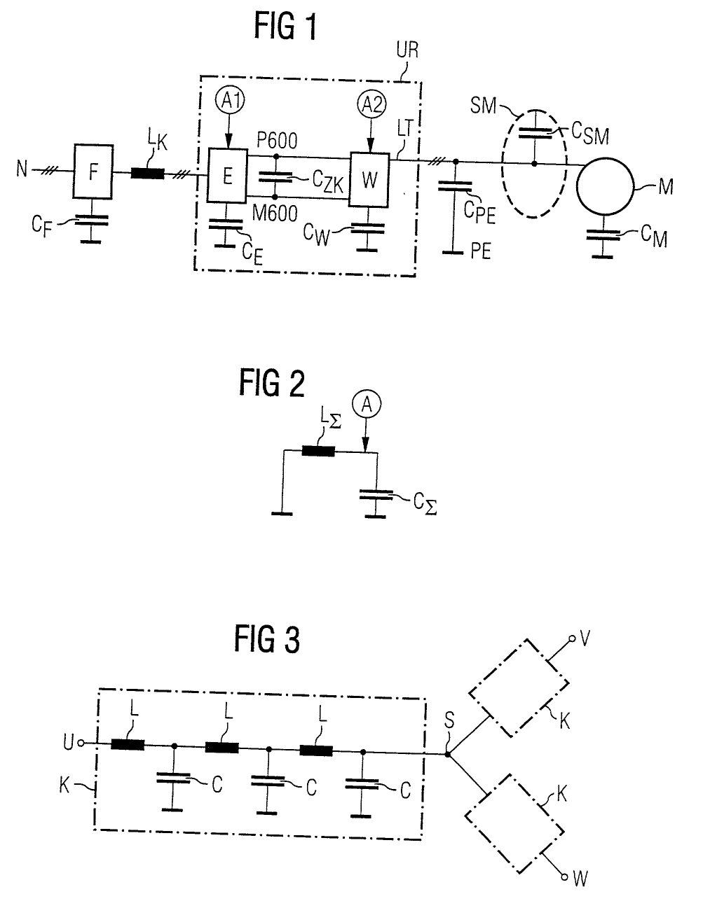

Such a converter system with a voltage intermediate circuit which is preferably used, inter alia, for main drives and servo drives in machine tools, robots and production machines owing to a very wide frequency and amplitude control range, is shown in the form of an outline sketch in the illustration in FIG. 1.

The converter UR is connected via a filter F and an energy-storage inductor, whose inductance is Lₖ, to a three-phase mains system N. The converter UR has the described feeder E, a voltage intermediate circuit with the energy storage capacitance C_{ZK} and an output inverter W. The illustration shows a regulated feeder E, which is operated in a controlled manner by means of switching components (for example a three-phase bridge circuit composed of IGBT transistors), as a result of which the arrangement as shown in FIG. 1 experiences a stimulus A1. The inverter W is likewise controlled via further switching components, for example once again by means of a three-phase bridge circuit having six IGBT transistors. The fact that switching operations also take place in the inverter likewise represents a stimulus A2 to the system. The capacitor C_{ZK} in the voltage intermediate circuit is connected between the positive intermediate circuit rail P600 and the negative intermediate circuit rail M600. The inverter is connected on the output side via a line LT and by means of a protective-ground conductor PE and a shield SM to a motor M, in the form of a three-phase machine.

The fixed-frequency three-phase mains system N now feeds the intermediate circuit capacitor C_{ZK} via the filter F and the energy-storage inductor L_{K} by means of the regulated feeder and via the input converter E, with the input converter E (for example a pulse-controlled converter) operating together with the energy-storage inductor L_{K} as a step-up controller. Once current has flowed through the energy-storage inductor L_{K}, it is connected to the intermediate circuit and forces the current against the greater voltage into the capacitor C_{ZK}. This also allows the intermediate circuit voltage to be kept above the peak value of the mains system voltage.

This combination thus effectively represents a DC voltage source. The inverter W uses this DC voltage in the manner described to again form a three-phase voltage system in which, in contrast to the sinusoidal voltage from a three-phase generator, the output voltage does not have an ideal sinusoidal oscillation profile, but also has harmonics in addition to the fundamental, since it is produced electronically via a bridge circuit.

In addition to the described elements in such an arrangement, however, it is also necessary to remember that parasitic capacitances occur which assist the formation of system oscillations in such a converter system. For example, in addition to the filter F with a discharge capacitance C_{F}, the input converter E, the inverter W and the motor M also have discharge capacitances C_{E}, C_{W} and C_{M} to ground. Furthermore, the line LT also has a capacitance C_{PE} to the protective-ground conductor PE, and a capacitance C_{SM} to the grounded shield SM.

The inventors have now recognized the fact that these system oscillations are stimulated in a particularly pronounced manner in the feeder E. Depending on the control method chosen for the feeder, two or three phases of the mains system N are in this case short-circuited, in order to cause current to flow through the energy-storage inductor L_{K}. If all three phases U, V, W are short-circuited, then either the positive P600 or the negative intermediate circuit rail M600 is rigidly locked to the star point of the supply mains system (generally close to ground potential depending on the zero system component). If two phases of the mains system N are short-circuited, then the relevant intermediate circuit rails P600 and M600 are rigidly locked to an inductive voltage divider from the two mains system phases.

Depending on the mains system voltage situation, this voltage is close to ground potential (approximately 50-60 V). Since the intermediate-circuit capacitance C_{ZK} is generally large (continuous voltage profile), the other intermediate circuit rail 600V is lower or higher, and may thus also drag down the remaining mains system phase. In both situations, the intermediate circuit is particularly severely deflected from its “natural”, balanced rest position (+/−300 V with respect to ground), thus representing a particularly powerful stimulus to system oscillation.

With regard to the production of undesirable system oscillations, the frequency band which is relevant for the field of application from less than 50 to 100 kHz allows a resonant frequency to be calculated with concentrated elements. In this case, the discharge capacitances C_{F} to ground in the filter F are generally so large that they do not govern the frequency. In this case, it can be assumed that there is a dominant stimulus to oscillations before the described capacitances, and the filter discharge capacitance C_{F} can be ignored.

The resonant frequency fᵣₑₛ(sys) of this system, which is referred to as f_{sys} in the following text, thus becomes:

$${f}_{sys} = \frac{1}{2 π \sqrt{{L}_{\sum } \cdot {C}_{\sum }}} \qquad ( 1 )$$

where

C_{Σ}=L_{K}+L_{F} (2)

where L_{K} represents the dominant component and L_{F} the unbalanced inductive elements in the filter (for example current-compensated inductors) which act on the converter side, and

C_{Σ}=C_{E}+C_{W}+C_{PE}+C_{SM}+C_{M} (3)

This expression is shown schematically in the illustration in FIG. 2. In this case, L_{Σ}and C_{Σ}form a passive circuit, which is stimulated by a stimulus A and starts to oscillate at its natural resonant frequency f_{sys}.

In consequence, the potentials on the intermediate circuit rails P600 and M600 are modulated, in addition to the shifts with an amplitude of 600 V, for example, resulting from the operating procedure, with an additional undesirable oscillation at an amplitude of up to several hundred volts.

In electric motors M in general, but particularly when they are designed using field coil technology (for example torque motors), a frequency response with pronounced resonant peaks with respect to ground potential can occur if they are stimulated in the common mode with respect to ground at all the motor terminals, for example by the undesirable system oscillations described above.

These resonance points can be explained by an unbalanced equivalent circuit formed by a lattice network circuit K with parasitic elements (inductances L and discharge capacitances C) in the motor winding, as is outlined schematically in FIG. 3. In this case, the winding section for one phase U of a three-phase motor M having the three phases U, V, W is shown by way of example, and in this case the winding sections thereof are electrically connected to one another at the motor star point S. The input voltages of the three-phase current generated by the inverter W are applied to the outer terminals of the respective winding sections opposite the star point S.

This relates in particular to motors using field coil technology, in which individual lattice four-pole networks of the lattice network K are macroscopically plausible by virtue of the design, and essentially correspond to an individual field coil. With field coil technology, the magnet cores, which are composed of electrical laminations, have teeth which act as pole cores, onto which prefabricated coils are placed, and are wired up as appropriate. As can be seen from FIG. 3, the individual inductances L are electrically connected in series, with each field coil having a capacitive coupling to the pole core (electrical lamination), on which the coil is mounted. These respective capacitances are shown as discharge capacitances C to ground, and are formed by the magnetic core.

However, the described phenomenon can also be explained for motors whose configuration is different (for example using what is referred to as a wild winding) by a model of a lattice network K, since this represents an equivalent circuit with identical four-pole networks in the form of LC tuned circuits, whose elements simulate the frequency response.

In this case, the peak occurs in the region of the star point S, which is normally not deliberately subjected to voltage loads. If the system oscillation of the converter is near a motor's natural frequency, then the insulation system to ground, in particular at the star point S, can be overloaded, leading to premature failure of the motor M, since the resonance results in considerably greater voltages at the motor star point than those which can occur at the motor terminals.

This statement applies in principle to all voltage levels (low-voltage, medium-voltage and high-voltage systems), but particularly when, firstly, the step-up controller principle (with an energy-storage inductor L_{K}) is being used on the converter side UR and a frequency response with pronounced resonant peaks with respect to ground potential occurs on the other side in the motor M, for example in motors with a particularly low motor natural frequency since, in this case, the intrinsic damping in the motor resulting from any eddy current losses, remagnetization losses etc., is particularly low.

Similar problems occur repeatedly in the field of electrical machines when transient overvoltages occur. The overvoltages are thus limited, in order to avoid flashovers. For example, according to DE 38 26 282 A1, a voltage-dependent metal-oxide resistor is connected in parallel with a coil in order to limit overvoltages. In DE 28 34 378 B2, winding sections are short-circuited in order to damp transverse fields. Transient overvoltages are damped in a similar way by transverse-field damper bars in a synchronous machine, according to DE 24 33 618 A1.

Furthermore, a description is given in EP-A-0 117 764 as to how overvoltages which occur due to resonance phenomena can be suppressed by ferroelectrical insulators between the coil windings. Finally, EP-B-0 681 361 addresses the problem of higher-order harmonic oscillations, which can occur in converters and rectifiers using power thyristors. The damper winding is in consequence connected to capacitors, in order to form resonant circuits. The resonant circuits have a resonant frequency which is 6n times as high as the fundamental frequency of the synchronous machine. Higher-order harmonic oscillations on a fundamental can thus be absorbed.

The problem of possible resonant peaks at the star point S of a motor M still remains, however.

The object of the present invention is thus to effectively avoid resonant peaks stimulated by such system oscillations in an electric motor operated using such a converter system.

According to the present invention, this object is achieved by a method for damping resonant peaks at a motor star point in the case of an electric motor which can be operated using a voltage intermediate-circuit converter having an input-side inductance, in particular a mains system input inductor, and which, on the basis of the characteristics of its winding sections, has a frequency response with at least one resonant frequency with respect to ground potential, in that the materials which are used for the stator in the motor are such that they result in increased losses being produced in the region of system oscillations, which are stimulated asymmetrically with respect to ground potential, in the converter system, in particular in the frequency range above 10 kHz.

Furthermore, the object of the invention is achieved by an electric motor for operation using a voltage intermediate-circuit converter having an input-side inductance, in particular a mains system input inductor, having a frequency response which is governed by winding inductances and discharge capacitances, with pronounced resonance with respect to ground potential, in which the motor has stator materials such that they produce increased losses in the region of system oscillations, which are stimulated asymmetrically with respect to ground potential, in the converter system, in particular in the frequency range above 10 kHz.

It has been found to be advantageous, both for the motor and for the method according to the invention, for increased losses to be produced in the capacitive elements of the motor in the region of system oscillations, which are stimulated asymmetrically with respect to ground potential, in the converter system.

This can be achieved particularly well by means of lossy dielectric materials having a relative dielectric constant with a corresponding frequency-dependent loss factor.

In this case, it has been found that appropriate dielectric materials can advantageously be used for the main insulation, in particular in the slot cell lining of the motor stator.

In addition, appropriate dielectric materials can also be used for the wire insulation and/or phase insulation.

Another advantageous refinement of the invention produces increased losses in the inductive elements of the motor in the region of system oscillations, which are stimulated asymmetrically with respect to ground potential, in the converter system.

This is achieved particularly well in that corresponding frequency-dependent eddy current losses are produced deliberately in the core material of the motor. One possible way to achieve this is to increase the thickness of the stator laminates of the motor until sufficient frequency-dependent eddy current losses in the region of critical system oscillations are produced in them.

These measures have been found to be advantageous in particular in the case of electric motors having winding sections using field coil technology, which each form a lattice network structure comprising inductances and discharge capacitances, when the losses produced by means of the stator materials which are used are used to damp these network lattice structures. This applies in particular to the situation where the stator materials which are used are designed such that they damp common-mode currents, which are stimulated asymmetrically with respect to ground on the motor phases, of the converter system in the network lattice structure.

However, the principle of the invention can also be applied to any other desired forms of electric motors, particularly also to those using what is referred to as wild winding technology, in particular low-voltage motors. This has been found to be particularly advantageous for those drives which have large geometric dimensions and in which a large slot area leads to large discharge capacitances, which lead to particularly low resonant frequencies fᵣₑₛ.

This is because, provided such pronounced resonance points in the motor are well above possible system oscillations in the converter system, the risk of resonant peaks at the motor star point is low. However, this situation changes the closer such resonant frequencies in the frequency response of a motor with respect to ground potential come to the area of such system oscillations in the converter system. This is governed primarily by the physical size of the motor itself. The size of a motor governs the slot area which itself affects the capacitance C_{M} of the motor with respect to ground potential, in that this discharge capacitance increases with the size of the slot area. As the discharge capacitance C_{M} of the motor increases, the pronounced resonant frequency fᵣₑₛ of the amplitude/frequency response of the motor with respect to ground potential in turn falls, and thus comes closer to the area of undesirable natural system frequencies f_{sys} in the converter system. This means that, as the geometric size of the motor increases, for example its physical length or diameter, pronounced resonant frequencies come closer to this critical range, and the problem of resonant peaks increases.

The present invention actively and effectively counteracts this by means of the measures described above, by creating a way to change the frequency response of the motor with respect to ground potential such that pronounced resonant peaks fᵣₑₛ in the vicinity of the natural system frequencies f_{sys} of the converter system shown in FIG. 1 are greatly attenuated.

Further details and advantages of the invention will become evident from the following description of an advantageous exemplary embodiment and in conjunction with the further figures. In this case, elements having the same functionality are annotated by the same reference symbols. In the figures:

FIG. 1 shows a block diagram of a converter system with a three-phase motor using a converter with a voltage intermediate circuit and a controlled input converter, and a mains system input inductor in the step-up controller mode,

FIG. 2 shows an equivalent circuit of the passive circuit formed by the arrangement of a converter system as shown in FIG. 1, with regard to system oscillations,

FIG. 3 shows an outline sketch of a lattice network structure formed in a motor,

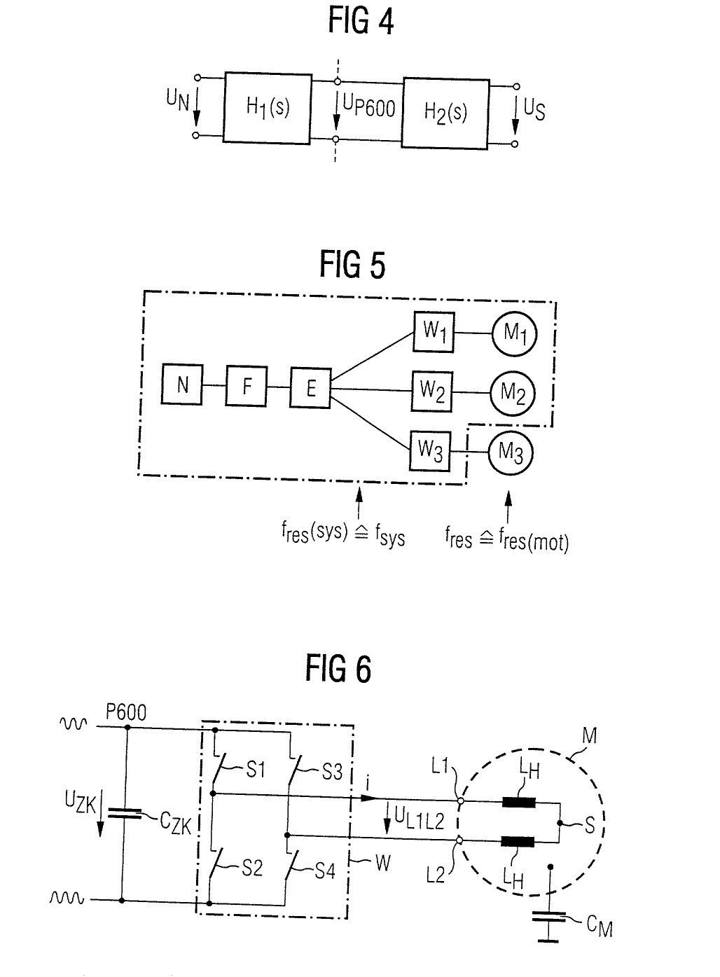

FIG. 4 shows an outline sketch in order to provide a system-theoretical description of the effective path of the voltages with respect to ground potential from the mains system to the motor star point,

FIG. 5 shows a schematic block diagram of a topology for a converter system,

FIG. 6 shows an outline sketch of a balanced drive for the motor from the voltage intermediate circuit on the basis of two phases L1 and L2,

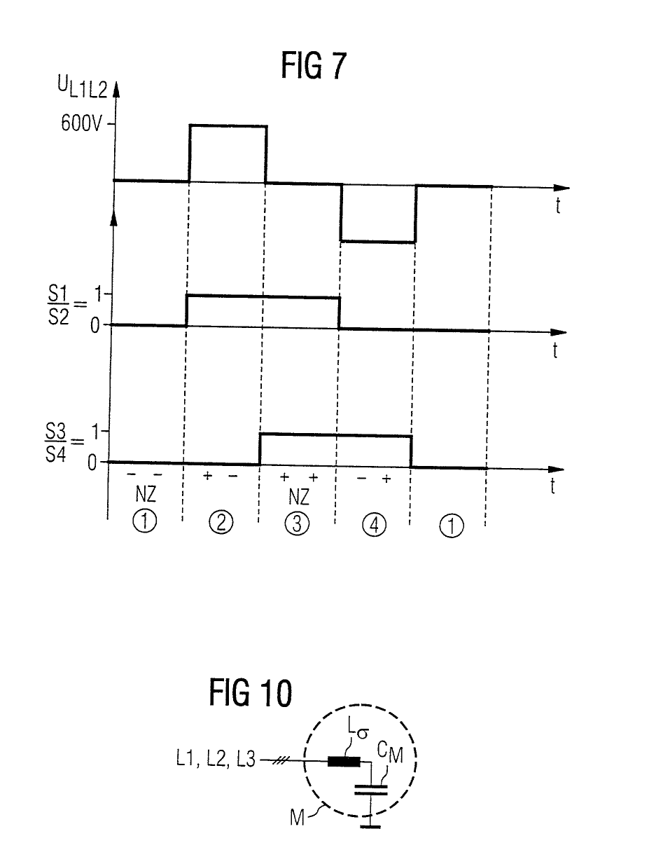

FIG. 7 shows a timing diagram of the voltage profile between these two phases L1 and L2, in comparison with the switching states of the inverter W,

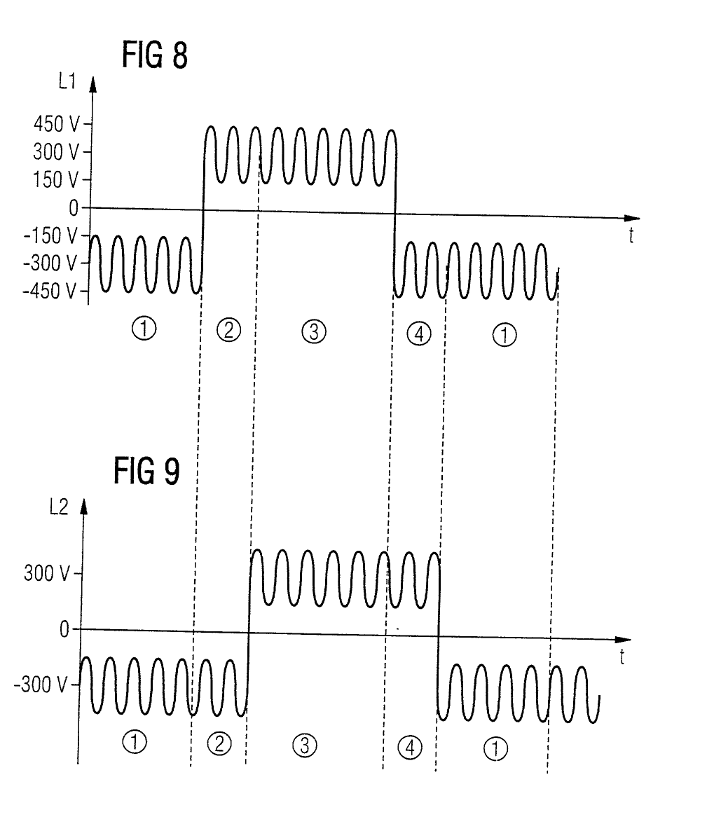

FIG. 8 shows a timing diagram of the voltage profile of the phase L1 with respect to ground,

FIG. 9 shows a corresponding timing diagram of the voltage profile of the phase L2 with respect to ground,

FIG. 10 shows an outline sketch of an unbalanced drive for the motor from the voltage intermediate circuit as a common-mode system for consideration of one phase to ground,

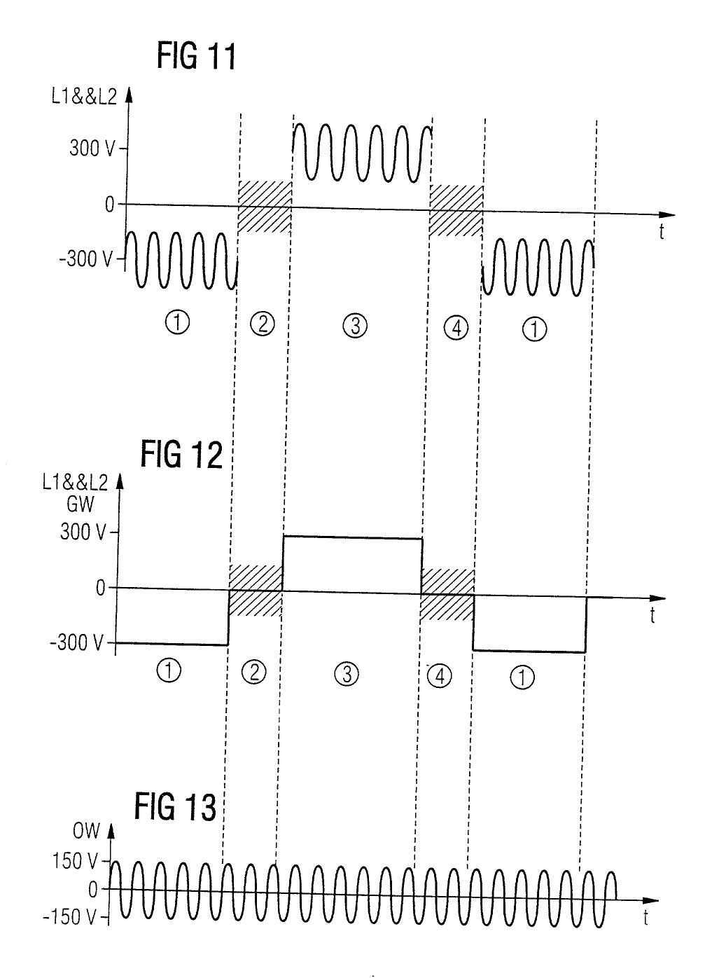

FIG. 11 shows a timing diagram of the unbalanced voltage profile of the phases L1 and L2 with respect to ground,

FIG. 12 shows a corresponding timing diagram of the DC component of the unbalanced voltage profile of the phases L1 and L2 with respect to ground,

FIG. 13 shows a corresponding timing diagram of the AC component of the unbalanced voltage profile of the phases L1 and L2 with respect to ground,

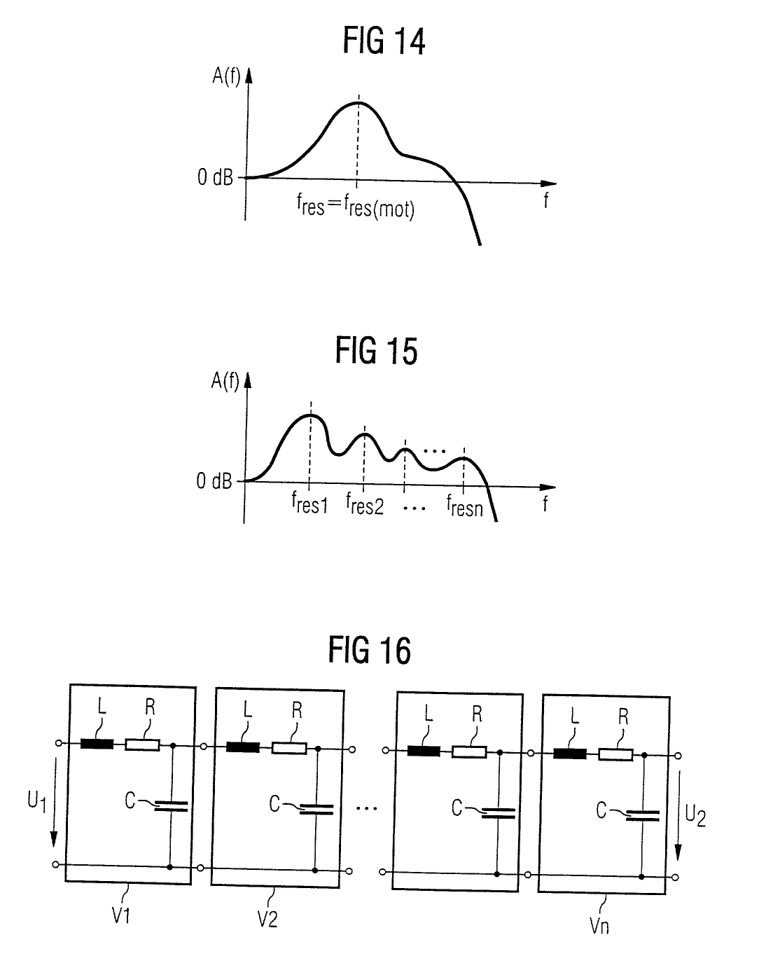

FIG. 14 shows an amplitude/frequency response of any given motor with respect to ground, in order to illustrate the transfer function H₂(s),

FIG. 15 shows an amplitude/frequency response of a motor with respect to ground, ignoring the intrinsic damping, which increases as the frequency rises, in order to illustrate the transfer function H₂(s),

FIG. 16 shows an outline sketch of a lattice network structure comprising four-pole networks,

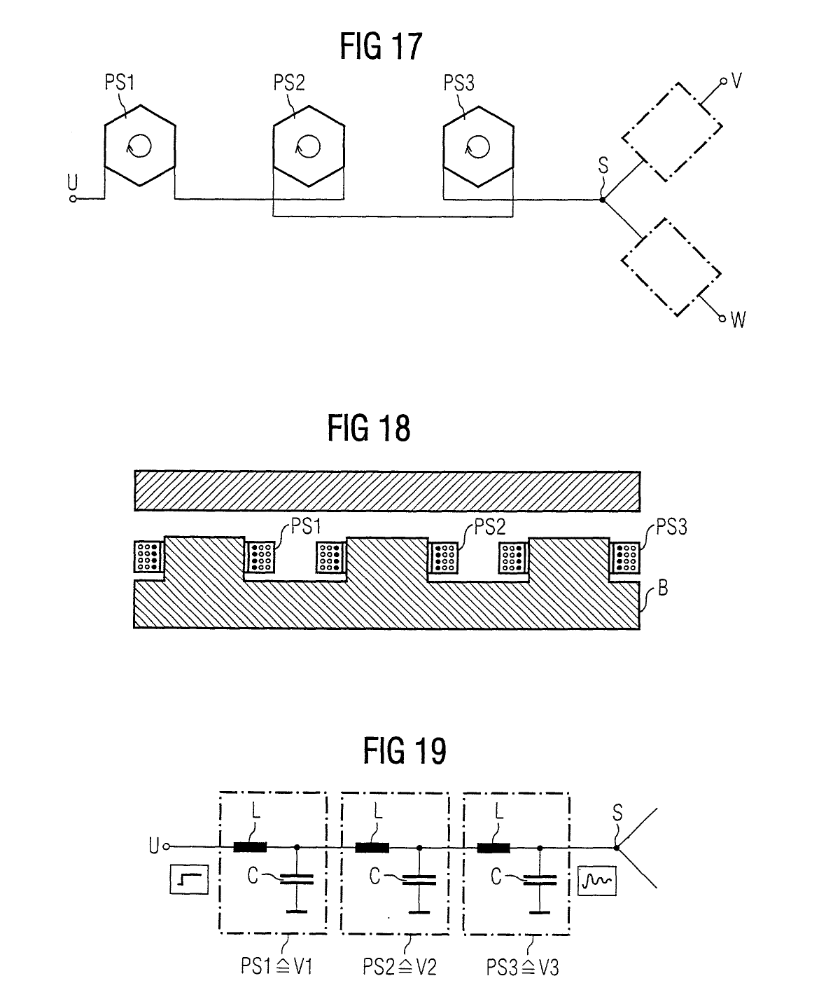

FIG. 17 shows an example of a winding layout for a motor winding using field coil technology,

FIG. 18 shows a cross-sectional view of the installed position of these field coils in the laminated core,

FIG. 19 shows the unbalanced equivalent circuit of such an arrangement as shown in FIG. 17 and FIG. 18,

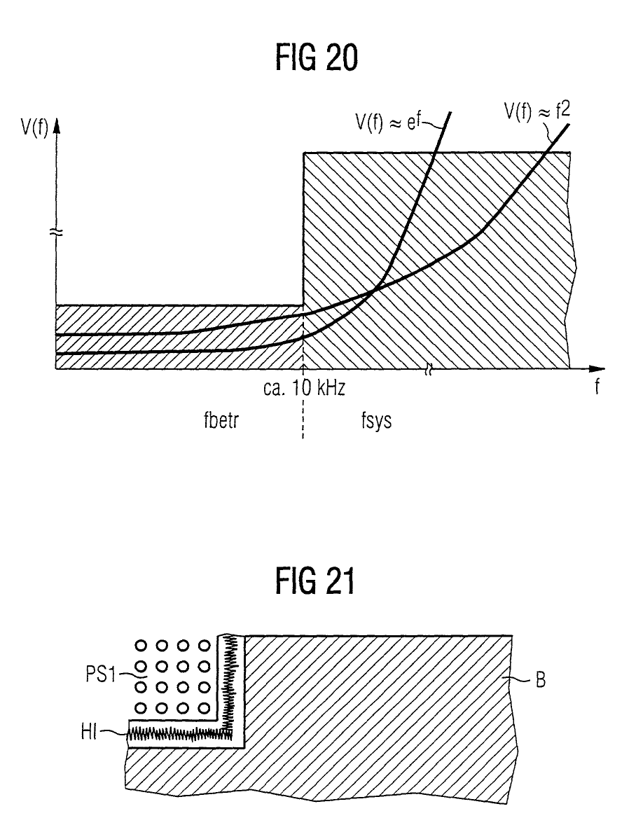

FIG. 20 shows an outline sketch of idealized loss production in the motor, plotted against frequency,

FIG. 21 shows a cross-sectional view of a field coil winding on the stator laminate as shown in FIG. 18, with the losses being influenced via the main insulation as a capacitive element,

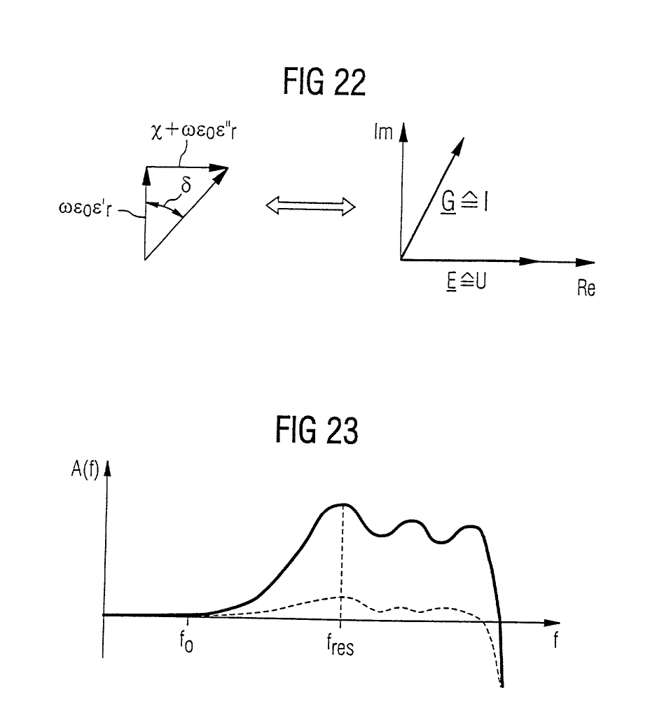

FIG. 22 shows a geometric illustration of the loss factor that is to be influenced, as a complex electrical variable, and

FIG. 23 shows a comparison of the amplitude/frequency response (amplitude profile plotted against frequency) with and without deliberate loss production according to the invention.

FIG. 1 to FIG. 3 have already been explained, initially, in order to allow better understanding of the problems on which the invention is based, although it should be mentioned once again at this point that identification of the problems of system oscillations in a converter system as shown in FIG. 1, particularly with a mains system input inductor Lₖ in the step-up controller mode and in conjunction with a motor with a lattice network structure K, and their cause, are not known from the prior art. This in itself is thus regarded as a considerable advance resulting from the present invention.

First of all, the system theory of such a converter system as shown in FIG. 1 will be assessed with regard to an effective path from the mains system to the motor star point. To this end, FIG. 4 shows a corresponding outline sketch with the input-side mains system voltage U_{N} with respect to ground, which is converted with respect to ground by the converter system with a first transfer function H₁(s) to the voltage U_{P600} on the positive intermediate circuit rail. In the motor, this voltage U_{P600} is converted via a second transfer function H₂(s) to a voltage Uₛ which is present between the motor star point S and ground.

In this case, it must be remembered that, in practice, a number of motors are often operated from one converter system, by feeding a number of inverters W₁ to W₃ with connected motors M₁ to M₃ from the intermediate circuit voltage U_{ZK}. The illustration of FIG. 5 shows an example of a topology of such a converter system. The input converter E is fed from the mains N via the filter arrangement F, and feeds a number of inverters W₁ to W₃ with connected motors M₁ to M₃ from the intermediate-circuit voltage U_{ZK}.

Between the respective inverters W₁ to W₃ and the connected motors M₁ to M₃, it must be remembered, with regard to system oscillations, that the converter system comprising N, F, E, W₁ to W₃ has a system natural frequency f_{sys}, which describes the resonant frequency fᵣₑₛ (sys) of the system. In contrast, the motors M₁ to M₃ themselves have their own resonant frequency fᵣₑₛ, which corresponds to the natural frequency fᵣₑₛ(mot) of the respective motor.

The system-theoretical analysis shown in FIG. 4 is therefore separate for the respective motor, for which reason the converter system with the transfer function H₁(s) comprises, for a topology as shown in FIG. 5, the filter F, the inductance L_{K}, the input converter E, all the inverters W, all the other motors M and all the lines LT.

In a converter system such as this, or in a converter system in general, a system oscillation can be formed, as described initially, which is stimulated in particular by the pulsing of a feeder E and, to a lesser extent, also by the pulsing of the inverters W in the shaft modules. This pulsing results in periodic charge reversal in the parasitic capacitances, as has already been explained with reference to FIG. 1.

If the mains system voltage U_{N} is regarded as an input variable, then this is mapped by the transfer function H₁(s) onto the output variable U_{P600} (if one considers the positive intermediate circuit rail P600). Except for 600 V DC components, the voltage U_{P600} is applied in the common mode to the motor terminals, thus corresponding to an unbalanced system or zero system.

In theory, the motor line LT can be associated both with H₁(s) and with H₂(s). Qualitatively, the statements apply to both situations. Here, it is assumed—as mentioned—that the motor line LT is associated with H₁(s). In the frequency band under consideration, the line LT can be regarded as being an electrical short.

As already mentioned, the passive circuit formed in this way and shown in FIG. 2 has a natural resonant frequency fᵣₑₛ(sys) or f_{sys} at which this system starts to oscillate. In consequence, the potentials on the intermediate circuit rails P600 and M600 are modulated with an additional, undesirable oscillation with an amplitude of up to several hundred volts in addition to the shifts with an amplitude of 600 V, for example, by virtue of operation.

This means that the output voltages from the inverter W with respect to ground are no longer square waves, as is the case between two phases U, V, W, but the output voltages represent sections of system oscillations on the intermediate circuit rails P600 and M600.

This can best be illustrated if one considers the outline sketch, shown in FIG. 6, of a balanced drive for the motor M from the voltage intermediate circuit C_{ZK} on the basis of two phases L1 and L2, by way of example. The illustration shows the intermediate circuit with the intermediate circuit capacitance C_{ZK} and the intermediate circuit rails P600 and M600, from which, via a simplified inverter with a bridge circuit and having the switches S1 to S4, a voltage U_{L1L2} or a current i is produced for feeding two winding sections L1 and L2 (which are connected at the motor star point S) of the motor M, each having inductances L_{H}. The motor has the already explained discharge capacitance C_{M} to ground potential.

The illustration in FIG. 7 shows the profile of the voltage U_{L1L2} between the phases L1 and L2 plotted against time t compared with the respective switching states of the switches S1 to S4 in the bridge of the inverter W, likewise plotted with respect to time t, underneath. The switches S1 and S2 represent the first bridge arm, and the switches S3 and S4 represent the second bridge arm. In this case, switches in one phase are always inverted with respect to one another since, otherwise, the intermediate circuit would be short-circuited.

The four states 1, 2, 3 and 4 are assumed in order to illustrate the switching states of the two bridge arms S1/S2 and S3/S4. In state 1, S1=0, S2=1 and S3=0, S4=1 with the state “−−” for the phases L1 and L2. Thus, in this situation, so-called zero vectors NZ are switched, and the voltage U_{L1L2} between the phases L1 and L2 is zero.

In state 2, S1=1, S2=0 and S3=0, S4=1. This results in the state “+−” with a voltage U_{L1L2} of 600 V between the phases L1 and L2.

In state 3, S1=1, S2=0 and S3=1, S4=0. This results in the state “++”, so that so-called zero vectors NZ are switched once again, and the voltage U_{L1L2} between the phases L1 and L2 is zero.

Finally, in state 4, S1=0, S2=1 and S3=1, S4=0. This results in the state “−+” with a voltage U_{L1L2} of −600 V between the phases L1 and L2. A new state 1 then starts, and so on.

The illustration in FIG. 8 likewise shows the profile of the voltage on the phase L1 with respect to ground plotted against time t, that is to say considered in an unbalanced manner, for these states 1 to 4. In this case, the phenomenon described above can be seen, as a result of which the voltage profile is not an ideal square waveform, since the undesirable system oscillations of the converter system from FIG. 1 and FIG. 4 are modulated with, for example, an amplitude of approximately 150 V. The same applies in some circumstances to a constant amplitude shift for the unbalanced voltage profile of the phase L2 with respect to ground, which is shown in FIG. 9. It can be seen that both phases L1 and L2, and hence the intermediate circuit rails P600 and M600 as well, oscillate in time with one another. This means that there is always a “parallel” shift, that is to say there is no phase shift.

This clearly shows that the problem of possible resonant peaks is essentially caused by unbalanced currents i. For this reason, it is worthwhile analyzing the arrangement as a common-mode system, as is shown by the details in FIG. 10 in the form of an outline sketch of an unbalanced drive for the motor M from the voltage intermediate circuit C_{ZK}. It is thus assumed in this case that all the motor phases U, V, W or L1 to L3 form an inductance L_{σ} which is caused by the motor winding and is terminated by the discharge capacitance C_{M} to ground.

If one now once again considers the two phases L1 and L2, but now jointly in the common-mode system (referred to in the following text as L1&&L2), then this results in the voltage profile with respect to ground shown in FIG. 11. No common-mode signal can be sketched from the “parallel” shift, which can be seen in FIG. 6 and FIG. 7, of the individual phases L1, L2 in the common-mode system for L1&&L2 in states 2 and 4 since the phases L1 and L2 are at different potentials here (in the sketched situation the DC voltage separation is 600 volts). Since only two phases are considered, this is, on average and in common-mode terms, 0 volts. In the other states 1 and 3, the voltage profile of L1&&L2 corresponds to that of L1 in FIG. 8 and that of L2 in FIG. 9.

The voltage profile of L1&&L2 shown in FIG. 11 in the common-mode system can in this case be separated into a fundamental GW and a harmonic OW. These are shown separately in FIG. 12 and FIG. 13.

The voltage profile of the fundamental GW can be seen from the illustration in FIG. 12. In this case, it is clear that this describes the desired square-wave switching states with −300 V in state 1, OV in states 2 and 4 owing to the “parallel” shift and +300 V in state 3. The harmonic OW, shown in FIG. 13 of the voltage profile L1&&L2, describes an essentially constant sinusoidal profile with an amplitude of, for example, 150 V.

The harmonic or system oscillation is thus applied to the motor M in all states 1 to 4, as a result of which this phase-ground tuned circuit, as shown in FIG. 2, in the motor M is constantly stimulated. If this system oscillation is now in the vicinity of a motor natural frequency, or the motor M has a pronounced resonance in the vicinity of the frequency of the system oscillation, it is possible for undesirable resonant peaks to occur. A “maximum” oscillation of this phase-ground tuned circuit is generally prevented only by the breakdown of the harmonic as a result of the switching from one state to the next.

With regard to the system-theoretical analysis of the problems shown in FIG. 4, mentioned above, the amplitude of such a system oscillation f_{sys} in this case depends essentially on two factors. These are, firstly, the intrinsic damping in the system, which is inversely proportional to the Q-factor of the tuned circuit, and with the damping increasing as the frequency rises. The second factor is the stimulus, that is to say the nature of the feed (for example diode feed or regulated feed), and the magnitude of the intermediate circuit voltage U_{ZK}.

Particularly pronounced natural system oscillations can thus be observed in converter systems which have a large number of shaft modules W and motors M, and long motor lines LT.

The frequency range of the natural system oscillations f_{sys}, in this case generally extends from approximately 10 kHz for large converter systems to more than 50 kHz for relatively small converter systems.

The amplitude and frequency thus depend on the configuration and the physical extent of the system, for example:

the nature of the feed E (regulated or unregulated)

the number of shafts or motors M which are operated from a converter system UR, and

the length of the power lines LT.

It should thus be stated at this point that converter systems with a voltage intermediate circuit may exhibit natural oscillations on the intermediate circuit rails P600, M600 to ground. This is particularly pronounced in multi-shaft systems and in the case of regulated mains system feeds in the input converter E, particularly in the step-up controller mode. The motor M in an unbalanced system is thus stimulated virtually at a single frequency irrespective of the pulse patterns of the individual phases U, V, W or L1 to L3. This stimulus is mapped by the transfer function H₂(s) onto the output side, namely the voltage Uₛ at the star point S with respect to ground.

All electric motors M, irrespective of the type, have a transfer function H₂(s) with respect to ground, whose amplitude/frequency response A(f) is as shown in the illustration in FIG. 14. This has a pronounced resonant frequency fᵣₑₛ(mot) or fᵣₑₛ. The transfer function H₂(S) can in this case be described as:

H₂(s)=U_{P600}/Uₛ.

The frequency of the pronounced resonant peak of the motor depends on the inductive and capacitive elements in the motor with respect to ground, and is thus defined by:

$${f}_{res} ∝ \frac{1}{\sqrt{{L}_{M} \cdot {C}_{M}}}$$

where L_{M}=f(L_{PE}) is the effective inductance and C_{M}=f(C_{PE}) is the effective capacitance of the motor M with respect to ground potential PE or in the zero system, respectively. The precise functions in this case depend on the respective test method and the equivalent circuits being used.

If there are a number of star points S, then identical tuned circuits are connected in parallel. The capacitance per tuned circuit is in this case given by:

$$\tilde{C} ∝ \frac{{C}_{M}}{{Anz}_{s}} .$$

The inductance depends on the number of coils connected in series, with there being a number of star points S, particularly when using field coil technology. Since the individual coils may be regarded as being magnetically decoupled from one another, it can furthermore be stated that:

$$\tilde{L} ∝ \frac{{n}_{1 s}}{{Anz}_{s}}$$

where n_{1S} is the number of coil assemblies for one star point S, and Anz_{S} is the number of star points S.

It can thus be stated, for motors of the same size but with identical coil groups connected differently, that:

$${f}_{res} ∝ \frac{1}{\sqrt{\frac{1}{{Anz}_{s}} \cdot \frac{1}{{Anz}_{s}}}} ∝ {Anz}_{s} .$$

The influence of the motor size on the resonant frequency fᵣₑₛ can be estimated as follows:

$$C = \frac{ϵ \cdot A}{d}$$

where

A∝slot area∝D·LG,

where D is the diameter and LG is the length of the motor.

Thus, with regard to the influence of the motor size, assuming that the other characteristics are constant:

$${f}_{res} ∝ \frac{1}{\sqrt{slot area}} ∝ \frac{1}{\sqrt{D \cdot LG}} .$$

Ignoring the natural damping, which increases as the frequency f rises, resulting from eddy current losses, remagnetization etc. and particularly if the motor M is regarded as a lattice network K, as appears to be macroscopically plausible particularly in the case of motors using field coil technology since the coil groups are connected in series, this results in the amplitude/frequency response A(f) shown in FIG. 15. This has a number of local maxima which describe a number of resonant frequencies f_{res 1} to f_{res n}, with the first resonant peak f_{res 1}, which is at the lowest frequency, being dominant and thus representing the governing or pronounced resonant frequency fᵣₑₛ.

There are thus frequencies (particularly the lowest resonant frequency fᵣₑₛ) at which considerably higher voltages occur at the motor star point S than at the input terminals of the motor M and which, for example, are greater by a factor of 3 to 4. In this case, it can be confirmed that the resonant peak becomes higher the lower fᵣₑₛ is. Geometrically large torque motors are thus particularly at risk, in which resonance points fᵣₑₛ can be formed particularly easily over the slot area and over a number of star points S, and which are in the vicinity of, or are precisely at the frequency f_{sys} of the natural system oscillations.

This knowledge is significant if one considers the lattice network structure K as is shown in FIG. 3. This is because such a structure can be assumed not only macroscopically for motors using field coil technology, but in principle also for other types. For this purpose, the motor M together with its motor winding can be regarded, even in entirely general form, as a microscopic lattice network K composed of identical four-pole networks V1 to Vn, as is shown in the illustration in FIG. 16. Each four-pole network V1 to Vn in this case comprises an inductance L, which is connected in series with a non-reactive resistance R. The output voltage is in this case produced in parallel with a capacitance C, which is connected in the form of a voltage divider with L and R.

In order to illustrate this construction, the lattice network structure K will first of all be described once again, in more detail. To this end, FIGS. 17 to 19 show the construction of a motor winding using field coil technology, compared with its unbalanced electrical equivalent circuit. By way of example, the illustration in FIG. 17 shows a coil group in the phase U. Each coil group of the motor winding MW, comprising a number of series-connected field coils PS1 to PS3 (assuming this relates to a structure using field coil technology) forms a macroscopic LC lattice network with respect to ground, with an inductance L and a capacitance C. The start and end of this lattice network K are the input terminal and star point S of the motor M. As described above, this lattice network K has a number of resonant frequencies fᵣₑₛ.

If such a lattice network is energized at the start (phase to ground) for example with a sinusoidal waveform at its lowest natural frequency fᵣₑₛ, which is generally the most pronounced, then it can produce a considerably higher voltage at the end (star point S with respect to ground) than at the start. In the worst case, this voltage can lead to breakdown of the main insulation in the vicinity of the star point S.

Such sinusoidal excitation can be produced in particular by an inadvertent system oscillation f_{sys}, as described above, of the overall converter system, which is superimposed on the deliberate switching processes in the power sections.

The described mechanism is most clearly pronounced at rest since, in this case, all the phases U, V, W, or L1 L2, L3, are switched at the same time. The natural frequencies and damping levels of the lattice network K depend on the design of the motor winding, for example on:

the number of coils per path

the number of turns (inductance)

the shape of the coils (capacitance)

the encapsulation (capacitance)

The illustration in FIG. 18 shows how the unbalanced equivalent circuit of such an arrangement as shown in FIG. 19 is obtained from an example of a winding layout shown in FIG. 17 and the installed position of the field coils in the laminated core B.

The organization of the winding means that the first layer (indicated by shaded circles) of a field coil PS1 to PS3 always has a higher capacitance C with respect to the laminated core B (ground potential) than the other layers (indicated by empty circles).

The respective inductance L is formed by the respective field coil PS1, PS2, PS3 itself, assuming that the mutual inductance between the coils is initially negligible since, at the frequencies (for example 20 kHz) under consideration, the iron only slightly magnifies and guides the magnetic flux. This is confirmed by the fact that the removal of the secondary part scarcely changes the measured values (frequency, amplitude).

The illustrated structure has the same number of lattice network elements (n=3) as the number of field coils PS1 to PS3. If a winding section comprises m parallel-connected paths (lattice structures), then m=3 paths are connected in parallel for the phases U, V, W for operation with a zero vector NZ (simultaneous switching of all input terminals).

The damping provided in the system is not shown in FIG. 19. Initially, this should be regarded as the pure resistance value R of each inductance L.

In the following example, the variables L_{z}, C_{M}, m and n will be used to calculate the transfer function of the lattice network structure shown in FIG. 16 and comprising four-pole networks V1 to Vn from the phase terminals to the star point S for a motor M.

In this case, CM describes the winding-ground capacitance and L_{Z}, R_{Z} describe the impedance of one winding path. In this case, the expression winding path means the series-connected coils from a phase terminal U, V or W to a star point S, with any existing parallel connections within a winding section being disconnected.

This allows the parameters for a lattice network element or four-pole network to be defined as follows:

$$L = \frac{{L}_{z}}{n} C = \frac{{C}_{M}}{3 \cdot n \cdot m}$$

m: number of parallel paths

n: number of coils in series

Initially, the loss resistance R in the inductance L is set to be

$$R = \frac{{R}_{z}}{n}$$

with the value for R_{z} being determined in the series model, for example at 10 kHz.

This value can be only a first approximation since R is highly frequency-dependent and is determined at a lower frequency than the frequencies that actually occur.

The Z matrix of a single four-pole network element Zᵥ is given by:

$${\underline{Z}}_{v} = [ \begin{matrix}R + sL + \frac{1}{sC} & \frac{1}{sC} \\ \frac{1}{sC} & \frac{1}{sC}\end{matrix} ]$$

This allows the lattice matrix Aᵥ to be formed as follows:

$$\frac{1}{sC} \frac{1}{sC} ] {\underline{A}}_{v} = [ \begin{matrix}{S}^{2} LC + sRC + 1 sL + R \\ sC 1\end{matrix} ]$$

The A matrix for the entire lattice network K is then:

Aₜₒₜ=Aᵥⁿ

with the element

$${\underline{A}}_{tot} [ 1.1 ] = \frac{{\underline{U}}_{1}}{{\underline{U}}_{2}}$$

The amplitude/frequency response A(s) is thus, as a complex generalization of A(f):

$$A ( s ) = 201 g ( \vert \frac{1}{{A}_{tot} [ 1.1 ]} \vert ) indB .$$

If one assumes that the damping resistance R increases with frequency, then the higher resonant frequencies would be even more strongly damped.

If one uses the A matrix for the entire lattice network K to form the Z matrix, then the element Zᵢₙ is equal to the input impedance of the lattice network.

The input impedance is thus given by:

$${Z}_{m} = \vert \frac{{\underline{Z}}_{tot} [ 1.1 ]}{m . n} \vert = \frac{1}{m . n} \vert \frac{{\underline{A}}_{tot} [ 1.1 ]}{{\underline{A}}_{tot} [ 2.2 ]} \vert$$

The invention counteracts this by deliberately producing losses in the motor which damp a parasitic tuned circuit such as that described to ground in the region of critical resonant frequencies fᵣₑₛ. This relates in particular to the frequency range above 10 kHz. In this case, the processes in the real system (that is to say in the individual phases U, V, W and not in the zero system) and in particular in the region of the operating frequencies are intended to be adversely affected as little as possible.

Normal operating frequencies in this case are in the frequency band between 0 and 400 Hz. Higher-energy harmonics occur in the region of the clock frequency or in the region of twice the frequency, due to the stimulus. This clock frequency is normally between 1-2 kHz and 16 kHz. For multi-shaft, medium-power drive systems (for example 16 kW-120 kW input power), this frequency is approximately 4 kHz.

Thus, ideally, the losses produced in the motor in the circuit with respect to ground potential are virtually zero in the region of the operating frequencies fₒₚ, and high in the region of the parasitic natural system frequencies f_{sys}.

The illustration in FIG. 20 for this purpose shows the profile of such ideal loss production, with the loss V(f) being plotted against the frequency f. The losses rise sharply only from a critical value of, for example, approximately 10 kHz.

In reality, such loss production profiles can be achieved only approximately, with square-law (V(f)=f²) or exponential-law (V(f)=e^{f}) profiles occurring in the components involved. Losses can in this case be produced deliberately primarily by the selection of suitable materials, in particular stator materials. Capacitive and inductive elements can be used, in particular, for this purpose.

Deliberate losses in capacitive elements can be produced, according to the invention, in particular by means of dielectric losses. Such dielectric materials are used in the wire insulation, the phase insulation and in the main insulation, but primarily in the slot cell lining.

For circuits to ground, the main insulation HI is the primary factor, according to the invention. FIG. 21 shows such main insulation HI for an example of slot cell lining with a field coil winding PS1 in the form of a cross-sectional view through the grounded laminated stator core B. In this case, current flows as what is referred to as capacitive displacement current while the charges on the parasitic capacitances to ground, described earlier on, are being reversed.

The main insulation HI in this case uses a dielectric with a thickness d and with a relative dielectric constant εᵣ. The capacitance to ground formed by such main insulation HI is in this case:

$$C = \frac{{ϵ}_{0} \cdot {ϵ}_{r} \cdot A}{d}$$

where A is the slot area.

The thickness d of the main insulation HI is intended to be small, if possible, in order to allow the maximum filling of the slots with winding sections. It is thus recommended that the relative dielectric constant εᵣ be varied. This can be described, as a complex electrical variable, as follows:

εᵣ=ε′ᵣ₋ⱼε″ᵣ.

From which the following can be derived:

$$\begin{matrix} \underline{G} = & ( χ + j {ωϵ}_{0} {\underline{ϵ}}_{r} ) * \underline{E} = & \\ & ( χ + j {ωϵ}_{0} {ϵ}_{r}^{′} ) * \underline{E} & ( resistive component ) \\ + & ( χ + j {ωϵ}_{0} {ϵ}_{r}^{″} ) * \underline{E} & ( capacitive component )\end{matrix}$$

where

G: current density in the conductor

E: electrical field strength

χ: specific conductivity, which is zero for dielectrics.

The loss factor which can be achieved by influencing the relative dielectric constant εᵣ thus becomes:

$$tan δ = \frac{χ + jω \cdot {ϵ}_{0} \cdot {ϵ}^{″} r}{ω \cdot {ϵ}_{0} \cdot {ϵ}^{′} r} \approx \frac{{ϵ}_{r}^{″}}{{ϵ}_{r}^{′}}$$

subject to the condition that the specific conductivity χ is zero for dielectrics.

This mathematical relationship is illustrated geometrically in FIG. 22 by means of a vector diagram and the corresponding complex co-ordinate system with the real part Re and the imaginary part Im.

This loss factor tan δ is normally used to describe lossy dielectrics. This indicates one possible way to deliberately produce appropriate frequency-dependent losses according to the invention. If suitable dielectrics are chosen, on the basis of technical and scientific material aspects, it is thus possible to produce loss factors tan δ which extend to the desired situation shown in FIG. 20.

Another advantageous aspect of the invention is the selection and dimensioning of appropriate inductive elements for the motor M. This relates essentially to the magnetic core material (for example the stator laminate B). This can be achieved by redesigning the motor by deliberately causing losses in the upper frequency range around fᵣₑₛ. Hysteresis losses and eddy current losses are significant in this case.

Since, in principle, hysteresis losses increase in proportion to the frequency, due to the remagnetization of the material and the microscopic processes (shifting of the Weiss' domains and of the Bloch walls) that take place in this case, losses of this type are not advantageous for the purposes of the invention (FIG. 20).

However, the eddy current losses are suitable. At low frequencies (region of critical natural system frequencies f_{sys}), these increase with the square of the frequency f and with the square of the laminate thickness d in accordance with:

Pw≈f²*d².

At very much higher frequencies, on the other hand, current displacement resulting from the skin effect in the direction of the laminate surface becomes significant, so that in this case the losses now rise only in proportion to the frequency f.

Such eddy current losses are thus more suitable for deliberate production of losses in the frequency range shown in FIG. 20. This may be done, for example, by deliberately using thicker stator laminates even though this in principle has undesirable effects in the region of the operating frequencies, since the losses (and hence the damping) in the region of the natural system frequencies thus increase, the overall effect of which can be positive.

The illustration in FIG. 23 shows the amplitude/frequency response A(f) with respect to ground potential with and without deliberate loss production according to the invention by means of the measures described above. The undamped profile corresponds to that shown in FIG. 15, with the first resonant frequency as the most pronounced resonant frequency fᵣₑₛ. Damping of the undesirable common-mode processes according to the invention, as described above, results in the dashed-line profile, where the resonant peak at fᵣₑₛ is considerably lower. Thus, if this is in the vicinity of the natural system frequency f_{sys} of the converter system, there is no need to expect resonant peaks, with the described negative consequences.

The advantages of the invention are, firstly, a reduction in the load on the insulating system to ground, which improves the reliability and robustness of the motor. Secondly, there is no need for the motor to have expensive additional insulation, which reduces the motor load level, since the voltage load remains in areas which, based on the present prior art for low-voltage motors, are regarded as being reasonable using standard materials.

The same principle can also be applied when there are a number of motor star points S, as is the case, for example, in linear motors or torque motors. In principle, resonant peaks also exist in motors using what is referred to as wild winding (standard for low-voltage motors), so that the idea of the invention can also be used for these and other motors than the motors using field coil technology chosen for illustrative purposes.

1. A method for damping resonant peaks at a motor star point in the case of an electric motor which can be operated using a voltage intermediate-circuit converter having an input-side inductance, in particular a mains system input inductor, and which, on the basis of the characteristics of its winding sections, has a frequency response with at least one resonant frequency with respect to ground potential, in that the materials which are used for the stator in the motor are such that they result in increased losses being produced in the region of system oscillations, which are stimulated asymmetrically with respect to ground potential, in the converter system, in particular in the frequency range above 10 kHz.

2. The method for damping resonant peaks at a motor star point in the case of an electric motor which can be operated using a voltage intermediate-circuit converter having an input-side inductance, in particular a mains system input inductor, and which, on the basis of the characteristics of its winding sections, has a frequency response with at least one resonant frequency with respect to ground potential, in particular as claimed in claim 1, in that increased losses are produced in the capacitive elements of the motor in the region of system oscillations, which are stimulated asymmetrically with respect to ground potential, in the converter system, in particular in the frequency range above 10 kHz.

3. The method for damping resonant peaks as claimed in claim 2, in which the losses are produced by means of lossy dielectric materials having a relative dielectric constant with a corresponding frequency-dependent loss factor.

4. The method for damping resonant peaks as claimed in claim 3, in which appropriate dielectric materials are used for the main insulation, in particular in the slot cell lining of the motor stator.

5. The method for damping resonant peaks as claimed in claim 4, in which appropriate dielectric materials are used for the wire insulation and/or phase insulation.

6. The method for damping resonant peaks at a motor star point in the case of an electric motor which can be operated using a voltage intermediate-circuit converter having an input-side inductance, in particular a mains system input inductor, and which, on the basis of the characteristics of its winding sections, has a frequency response with at least one resonant frequency with respect to ground potential, in particular as claimed in claim 1, in that increased losses are produced in the inductive elements of the motor in the region of system oscillations, which are stimulated asymmetrically with respect to ground potential, in the converter system, in particular in the frequency range above 10 kHz.

7. The method for damping resonant peaks as claimed in claim 6, in which corresponding frequency-dependent eddy current losses are produced deliberately in the core material of the motor.

8. The method for damping resonant peaks as claimed in claim 7, in which the thickness of the stator laminates of the motor is increased until sufficient frequency-dependent eddy current losses in the region of critical system oscillations are produced in them.

9. An electric motor for operation using a voltage intermediate-circuit converter having an input-side inductance, in particular a mains system input inductor, having a frequency response which is governed by winding inductances and discharge capacitances, with pronounced resonance with respect to ground potential, in which the motor has stator materials such that they produce increased losses in the region of system oscillations, which are stimulated asymmetrically with respect to ground potential, in the converter system, in particular in the frequency range above 10 kHz.

10. The electric motor for operation using a voltage intermediate-circuit converter having an input-side inductance, in particular a mains system input inductor, having a frequency response which is governed by winding inductances and discharge capacitances, with pronounced resonance with respect to ground potential, in particular as claimed in claim 9, in which the motor has capacitive materials such that they produce increased losses in the region of system oscillations, which are stimulated asymmetrically with respect to ground potential, in the converter system, in particular in the frequency range above 10 kHz.

11. The electric motor as claimed in claim 10, in which lossy dielectric materials are provided, having a relative dielectric constant with a corresponding frequency-dependent loss factor.

12. The electric motor as claimed in claim 11, in which appropriate dielectric materials are provided for the main insulation, in particular in the slot cell lining of the motor stator.

13. The electric motor as claimed in claim 12, in which appropriate dielectric materials are provided for the wire insulation and/or phase insulation.

14. The electric motor for operation using a voltage intermediate-circuit converter having an input-side inductance, in particular a mains system input inductor, having a frequency response which is governed by winding inductances and discharge capacitances, with pronounced resonance with respect to ground potential, in particular as claimed in claim 9, in which the motor has inductive materials such that they produce increased losses in the region of system oscillations, which are stimulated asymmetrically with respect to ground potential, in the converter system, in particular in the frequency range above 10 kHz.

15. The electric motor as claimed in claim 14, in which the motor has a core material such that it produces appropriate frequency-dependent eddy current losses.

16. The electric motor as claimed in claim 15, in which the stator laminates of the motor have a thickness which ensures that adequate frequency-dependent eddy current losses in the region of critical system oscillations are produced in them.

17. The electric motor as claimed in claim 16, having winding sections using field coil technology, which each form a lattice network structure comprising inductances and discharge capacitances, in which the losses produced by means of the stator materials which are used are used to damp these lattice network structures.

18. The electric motor as claimed in claim 16, in which the stator materials which are used are designed such that they damp common-mode currents, which are stimulated asymmetrically with respect to ground on the motor phases, in the converter system in the lattice network structure.

19. The electric drive as claimed in claim 16 using what is referred to as wild winding technology, in particular a low-voltage motor, which has low resonant frequencies by virtue of its geometric and/or electrical construction.
